(19) United States
(12) Patent Application Publication
(10) Pub. No.: US 2004/0019654 A1
(43) Pub. Date: Jan. 29, 2004

(54) Method and apparatus for exercise regimen administration

(76) Inventors: Joseph Powers, North Brunswick, NJ (US); William C. Rehm, Lebanon, NJ (US)

Correspondence Address: Synnestvedt & Lechner LLP, 2600 Aramark Tower, 1101 Market Street, Philadelphia, PA, 19107-2950, US

(21) Appl. No.: 10/207,345

(22) Filed: Jul. 29, 2002

(51) Int. Cl. G06F 15/16

(52) U.S. Cl. 709/217

(57) ABSTRACT

A method and apparatus for electronic administration of an exercise regimen. The exercise regimen is prepared electronically by a therapist via a therapist interface displayed by an electronic device such as a PDA. The exercise regimen is customizable for the patient. Related exercise information may be retrieved and delivered to the patient in addition to the exercise regimen by wireless transmission to the patient's electronic device, such as a PDA, for viewing via a patient interface. The patient interface's display of information may be customized to present images and instructions specific to the exercises selected by the therapist and to display the name of the therapist and/or therapist contact information to allow for resolution of questions/concerns. Additionally, reminder messages may be provided to the patient to prompt performance of the exercises in accordance with the therapist-specified schedule. The therapist and patient devices may be configured to display selected advertising indicia.

### FIELD OF THE INVENTION

The present invention relates generally to healthcare, and particularly to administration of an exercise regimen using at least one electronic device, such as a personal digital assistant (PDA) or other computing device.

### DISCUSSION OF RELATED ART

Physicians, nurses, physical therapists, physical trainers and other healthcare consultants (collectively “therapists”) often have occasion to prescribe, assign, recommend or otherwise administer a treatment such as a medication, physical therapy or exercise regimen to a patient, client or other individual (collectively “patient”). Such treatments are typically administered to treat a malady, disease or other physical condition. For example, a physician may prescribe an exercise regimen to treat a patient having osteoporosis. Osteoporosis, like many conditions, is a condition treatable not only with exercise, but also by other means such as nutrition, medication, etc.

Such treatments are typically administered to a patient on note paper having handwritten, typewritten and/or other information. Such information may include a schedule for performing the exercise regimen. It is easy for a patient to lose such note paper and/or lose track of such a schedule.

When administering an exercise regimen, a therapist often provides a patient with a booklet of photocopied pages describing a broad spectrum of exercises. These pages describe a generic, comprehensive set of exercises, many of which are inappropriate for a particular patient. The therapist typically selects certain exercises appropriate for the patient by circling and/or highlighting the exercises that the therapist wants the patient to perform. These selected exercises constitute an exercise regimen prepared by the therapist for the benefit of the patient.

Because there is little or no customization of the exercise information presented, the patient often becomes confused as to which exercises the patient should perform. In addition, because such booklets are generic, there is typically no contact information for conferring with the therapist to resolve such confusion.

It is undesirably expensive to provide patients with booklets that include many exercises that the patient does not need to perform. Such paper copies are unwieldy, and are often lost by patients or ignored. Because of the tendency to lose such copies, the therapist often keeps a copy in the patient's medical records file. Maintenance of such records is also undesirably expensive.

Furthermore, repeated photocopying of such pages for distribution in booklets results in degradation of the photocopied images, which makes it difficult for the patient to read and/or understand the exercise information contained thereon.

### SUMMARY OF THE INVENTION

The present invention provides a method and apparatus for electronic administration of an exercise regimen. A customized exercise regimen for a patient is prepared electronically by a therapist using an electronic device, such as a personal digital assistant (PDA) or other computing device (“therapist device”), that is specially configured in accordance with the present invention to provide a therapist interface. Additional exercise information may be specified by the therapist and/or retrieved by the therapist device. The exercise regimen and related exercise information are then delivered to the patient, preferably by transmission of corresponding data. In a highly preferred embodiment, the data is wirelessly transmitted directly to an electronic device of the patient, such as a PDA or other computing device (“patient device”), that is specially configured in accordance with the present invention to provide a patient interface.

The patient interface displays information in a customized manner, in particular, to present images and instructions specific to the exercises selected by the therapist, and/or the name of the therapist and/or therapist contact information to allow for resolution of questions/concerns. Additionally, the data received from the therapist device may be used by the patient device to create and cause display of reminder messages via the patient interface. The reminder messages prompt the patient to perform the therapist-selected exercises in accordance with the therapist-specified schedule and/or exercise regimen.

In a highly preferred embodiment, the therapist device is configured to display selected advertising indicia, such as advertising indicia related to a condition treatable with exercise. In this manner, when the therapist operates the therapist device to prepare an exercise regimen for a patient having a condition treatable with exercise, the therapist is exposed to advertising indicia related to the patient's condition that may be beneficial to the patient. The patient interface, and/or a printout provided to the patient, may be similarly configured.

### BRIEF DESCRIPTION OF THE DRAWINGS

FIG. 1 is a diagram of an exemplary system for implementing the present invention.

FIG. 2 is a flow diagram of an overview of exercise regimen administration in accordance with an exemplary embodiment of the present invention.

FIG. 3 is a flow diagram of a detailed view of exemplary exercise regimen administration in accordance with the flow diagram of FIG. 2, taken from the therapist's perspective.

FIGS. 3A and 3B are plan views of exemplary therapist devices for carrying out the methods of FIGS. 2 and 3, and showing therapist interfaces in accordance with exemplary embodiments of the present invention.

FIG. 4 is a flow diagram of a detailed view of exemplary exercise regimen administration in accordance with the flow diagram of FIG. 2, shown from the patient device perspective.

FIGS. 4A and 4B are plan views of exemplary patient devices for carrying out the method of FIGS. 2 and 3, and showing patient interfaces in accordance with exemplary embodiments of the present invention.

FIG. 4C illustrates an exemplary printout of exercise regimen information produced in accordance with the method of FIG. 2.

FIG. 5 is a flow diagram of an exemplary method for promoting to a therapist a product relating to a condition treatable with exercise, in accordance with the methods of FIGS. 3 and 4.

FIG. 6 is a block diagram of an exemplary electronic device in accordance with the present invention.

### DETAILED DESCRIPTION

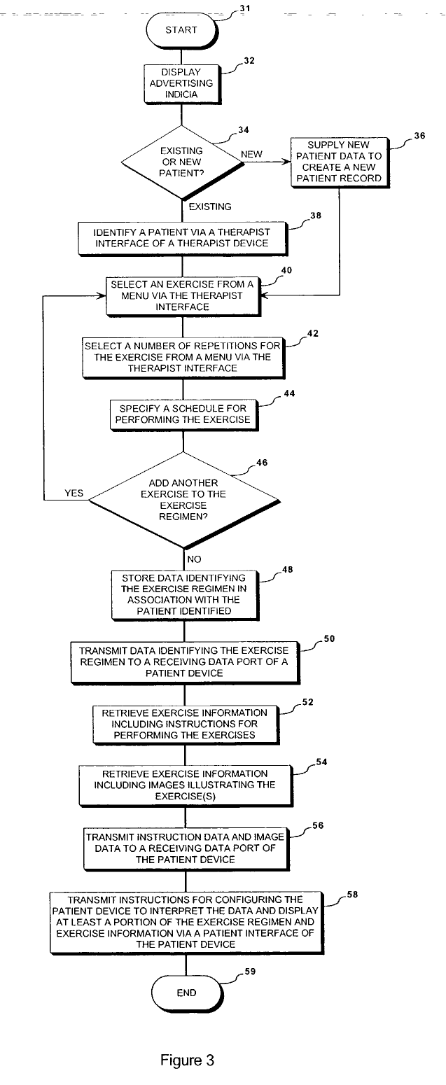

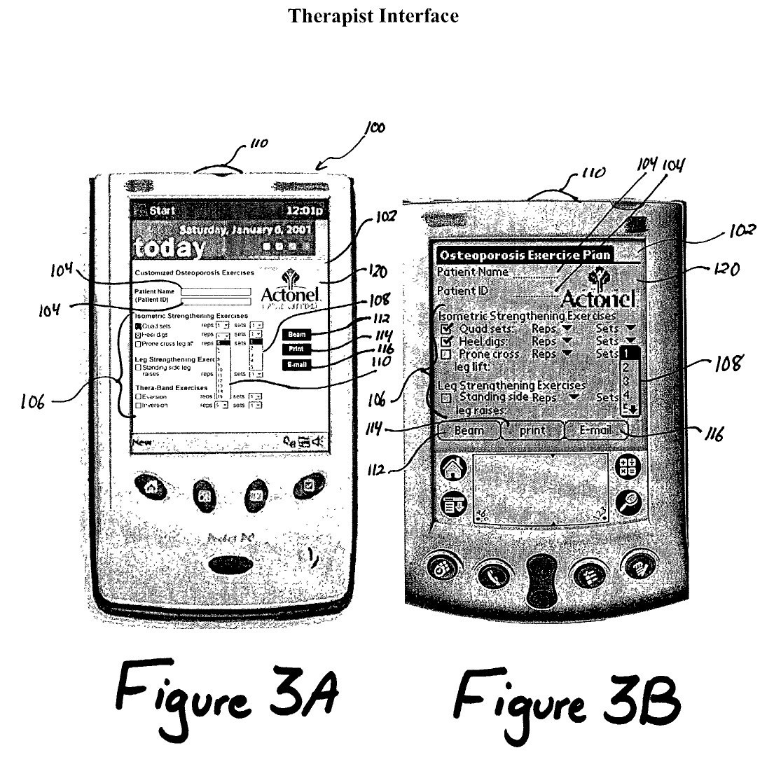

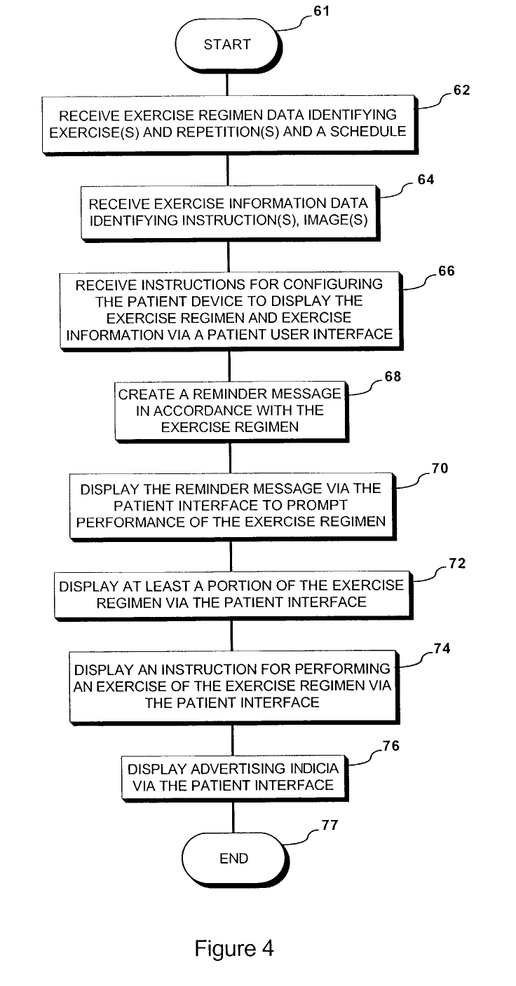

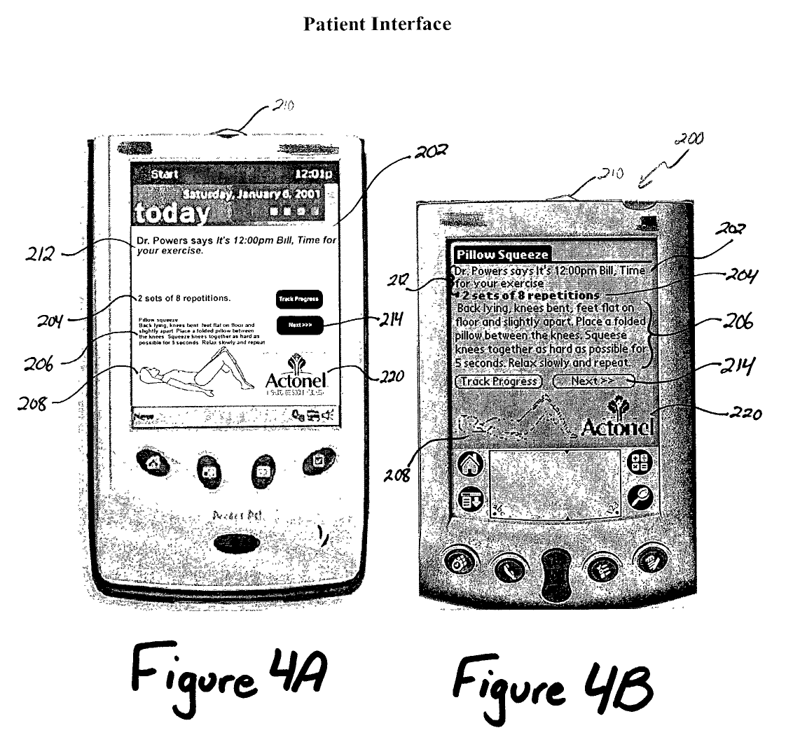

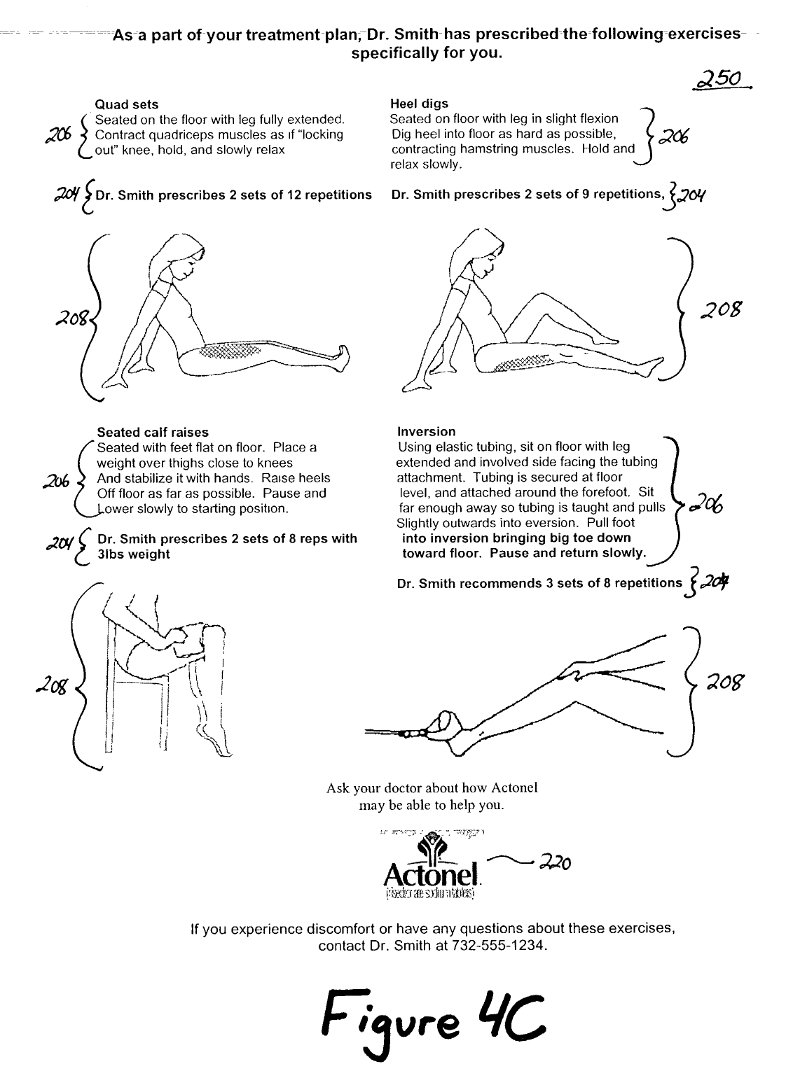

The present invention provides for electronic exercise regimen administration. In accordance with the present invention, a therapist may prepare an exercise regimen quickly and easily using an electronic device, such as a personal digital assistant (PDA), personal computer or similar computing device (hereinafter, “therapist device”), that is specially configured in accordance with the present invention to provide a specially configured graphical user interface for use by a therapist (hereinafter a “therapist interface”). The exercise regimen, and related information, is preferably delivered to a patient in data form by transmitting corresponding data from the therapist device to an electronic device of the patient, such as a personal digital assistant (PDA), personal computer or similar computing device (hereinafter, “patient device”), that is specially configured in accordance with the present invention to provide a specially configured graphical user interface for use by a patient (hereinafter a “patient interface”). For example, both the therapist device 100 and the patient device 200 may be a commercially available PDA such as an HP Jornada (see FIGS. 3A and 4A), which is manufactured and/or distributed by Hewlett-Packard Company of Palo Alto, Calif., U.S.A.,or a Palm V (see FIGS. 3B and 4B), which is manufactured and/or distributed by Palm, Inc. of Santa Clara, Calif., U.S.A. The patient device 200 interprets the received data and displays corresponding information to the patient via the patient interface.

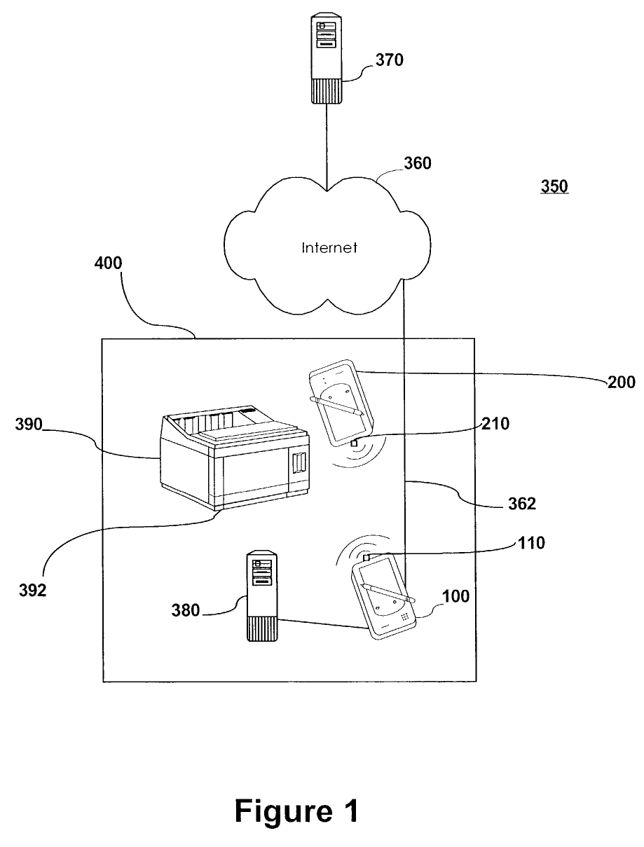

An exemplary system 350 for implementing the present invention is shown in FIG. 1. As shown in FIG. 1, the system 350 includes a therapist device 100 and a patient device 200. The therapist device 100 is capable of communicating via a communications network such as Internet 360 via a wired or wireless connection 362, as generally known in the art. For example, the therapist device 100 may communicate via the Internet 360 with application server 370 to download microprocessor executable instructions (e.g. software) for configuring an electronic device as the therapist device 100.

The therapist device 100 has a data transmission port 110 for “beaming” or otherwise wirelessly transmitting data representing an exercise regimen and other exercise information from the therapist device 100. The patient device 200 has a data receiving port 210 for receiving such data. Similarly, laser printer device 390 has a data receiving port 392 for receiving such data, although such information may be formatted differently and/or include additional data to allow printing by the printer device 390, as generally known in the art. It is understood that the therapist device 100, patient device 200, personal computer 380 and printer device 390 are preferably operated within a shared physical space 400, such as a doctor's office or other healthcare facility.

In addition, the therapist device is capable of communicating with a personal computer 380 or other data storage device for “synching” or otherwise downloading data from the therapist device 100 to data storage facilities of the personal computer, e.g. for long term data storage. Alternatively, an exercise regimen may be prepared via the personal computer 380 and transferred to the therapist device 100 for further transmission of the data.

Optionally, the patient device 200 and/or the application server 370 may be configured to communicate via the Internet 360 to download microprocessor executable instructions (e.g. software) for configuring a patient's electronic device as the patient device 200 to receive and interpret data in accordance with the present invention.

As discussed below, the therapist and patient preferably meet at the therapist's office or other shared physical space 400 and the therapist uses the therapist device 100 to prepare an exercise regimen and wirelessly transmit corresponding exercise regimen data to the patient device 200 via a short range wireless transmission (e.g. from one to five feet in range). In this manner, the exercise regimen is delivered electronically to the patient.

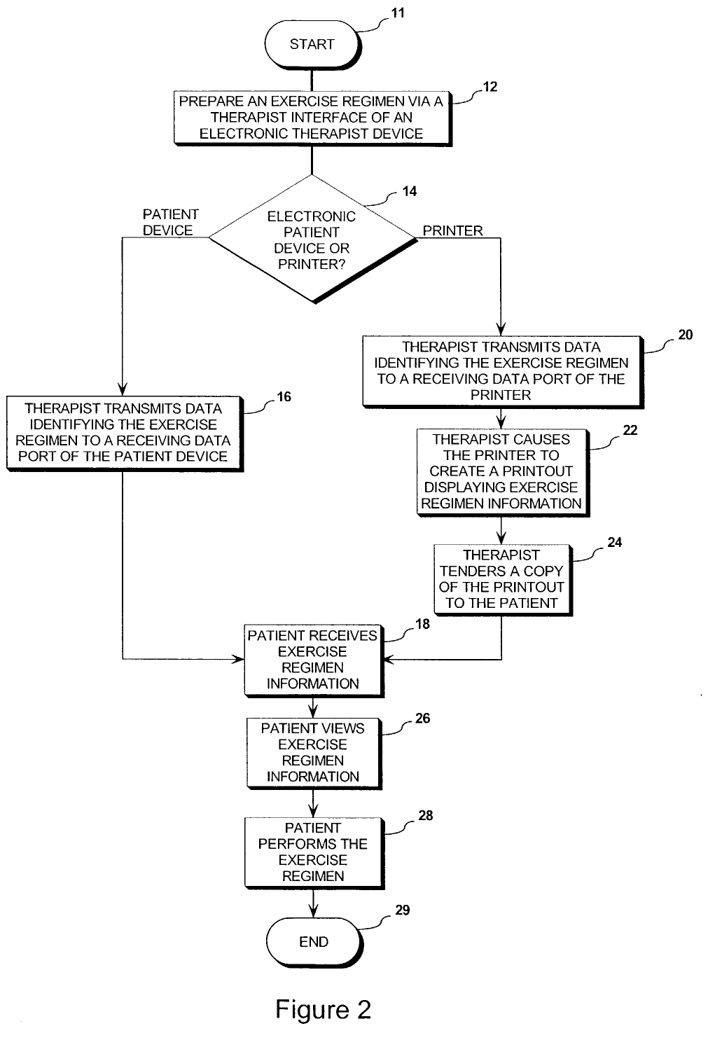

FIG. 2 is a flowchart illustrating an overview of exercise regimen administration in accordance with an exemplary embodiment of the present invention. At step 12, the therapist prepares an exercise regimen using the therapist device 100. The exercise regimen may be prepared quickly and easily by selecting exercises, repetitions, a schedule, etc. from menus displayed via the therapist interface 102, as discussed in detail below with reference to FIGS. 3, 3A and 3B. The therapist's input to the therapist device 100 is represented by corresponding data. The exercise regimen data may be inexpensively stored in electronic format, thereby eliminating the need for paper copies.

At step 14, a determination is made as to whether the exercise regimen information is going to be delivered via hard copy (in which case the exercise regimen is sent to a printing device 390) or electronically (in which case the exercise regimen is sent to the patient device 200).

If it is determined in step 14 that the exercise regimen information is going to be delivered electronically, then the therapist transmits corresponding data from the data transmission port 110 of his therapist device 100 to the data receiving port 210 of the patient device 200, as shown at step 16 of FIG. 2. Such data may include exercise regimen data as well as any data corresponding to related exercise information, such as instructions for performing exercises of the exercise regimen, images illustrating exercises of the exercise regimen, scheduling information for performance of the exercises of the exercise regimen, etc.

For example, a well-known wireless transmission “beaming” function of such PDA devices may be used for such data transmission. Such received information may be received and stored in electronic format in the patient device 200, as shown at step 18 of FIG. 2. This eliminates the need for handwritten notes and/or unwieldy booklets, etc. and allows the patient's device, which includes calendar, day planner and alarm functions as generally known in the art, to be configured to provide reminder messages to perform such exercises in accordance with the indicated schedule.

If it is determined in step 14 that the information will be delivered in hard copy format, then the process proceeds to step 20, where the therapist transmits the exercise regimen data and any exercise information data in a similar manner, but to a receiving data port 392 of the printer device 390, such as a conventional laser printer (FIG. 1). Such transmission may be made in any suitable manner, e.g. by infrared or other wireless transmission or via a physical network connection. In such an embodiment, the therapist (directly or indirectly via an assistant) then causes the printer device 390 to create a printout 250 displaying the exercise regimen (see FIG. 4C), as shown at step 22, and the printout 250 is tendered to the patient, as shown at step 24. FIG. 4C illustrates an exemplary printout 250. As shown in FIG. 4C, the printout shows exercise regimen information 204, exercise instructions 206, images 208 illustrating the exercise(s), advertising indicia 220 etc., and is therefore somewhat similar to the displays of the patient device 200. The printout 250 is customized to provide therapist contact information and patient information. Accordingly, the patient receives the exercise regimen information, as shown at step 18 of FIG. 2.

The exercise regimen information is highly customized. The patient device 200 and/or the printout 250 are configured to display only the patient-appropriate exercises and exercise information, to display contact information of the therapist, etc., and thereby reduce the opportunity for patient confusion. The patient may then view the exercise regimen and related exercise information and perform the exercise regimen accordingly, as shown at steps 26, 28 and 29 of FIG. 2. In appropriate embodiments, the patient participates in the electronic administration of the exercise regimen by using the patient device 200 to “follow along” while performing the exercise regimen.

The portion of FIG. 2 relating to transmission of data to a patient device 200 is discussed in greater detail below with reference to the flow diagram 30 of FIG. 3, which is shown from the therapist's perspective as the therapist interacts with the therapist device 100. The therapist operates the therapist device 100 as generally known in the art, e.g. by tapping a touch sensitive screen with a stylus, manipulating buttons and/or scroll wheels of the device, selecting hyperlinks, etc. However, the therapist device 100 is configured to provide novel functionality in accordance with the present invention, as discussed further below. Referring now to FIG. 3, steps 32-48 correspond to step 12 of FIG. 2.

The exemplary method has at least two basic phases from the therapist perspective, namely, preparing the exercise regimen and delivering the exercise regimen to the patient, both of which are performed, at least in part, using the therapist device 100. As shown at step 32 of FIG. 3, the method starts with display of advertising indicia, as discussed further below with reference to FIGS. 3A-5. The method continues with identification of a patient, either by supplying new patient data, such as name, patent identification code or other patient information, to create a new patient record, as shown at steps 34 and 36 of FIG. 3. For example, this may be achieved by typing, tapping a touch-sensitive screen or using other stylus-based text entry techniques known in the art. These optional steps 34, 36 are advantageous for record keeping purposes.

FIGS. 3A and 3B are plan views of exemplary therapist devices 100. As shown in FIGS. 3A and 3B, the therapist device 100 provides a therapist interface 102, e.g. a specially configured graphical user interface, in accordance with the present invention. Various hardware, software and programming techniques are well-known in the art for providing a desired graphical user interface, and any suitable techniques may be used. As shown in FIGS. 3A and 3B, the therapist interface 102 provides text entry fields 104 for receiving the supplied patient data. Various menu options (not shown) may be provided for saving new patient data in a memory of the therapist device, as is generally known in the art.

Alternatively, an existing patient (one for whom data has previously been supplied or for which a data record already exists) may be identified by selecting from a menu and/or using predictive typing techniques to match existing patient information with data supplied in the text entry fields. Various predictive typing techniques are well known in the art and any suitable technique may be used.

After a patient has been identified, the therapist prepares an exercise regimen for the patient via the therapist interface 102. In the exemplary method of FIG. 3, the therapist selects exercise options from menus via the therapist interface 102, as shown at step 40, e.g. by tapping the touch sensitive screen with a stylus, etc. as described above. A menu may be in the form of simple text with user-selectable check-boxes 106, as shown in FIGS. 3A and 3B, or in the form of a drop down or pull-down menu of user-selectable options, as known in the art. In the example of FIG. 3A, a simple text menu is shown that includes the following exercise options: Quad sets, Heel digs, Prone cross leg lift, Standing side leg raises, eversion and inversion. Use of a menu eliminates the need for the therapist to handwrite or use other painstaking text entry techniques.

At step 42, the therapist then selects an appropriate number of repetitions for performance of the exercise identified in step 40. This information is provided via the therapist interface 102, e.g. by selecting appropriate user-selectable options for sets and repetitions per set from corresponding drop down menus 108, 110, as shown in FIGS. 3A and 3B. In the example of FIG. 3A, these menus 108, 110 present exercise options for 1-5 sets and 1-15 repetitions. The identification of exercises, sets and repetitions per set is represented in exercise regimen data. The exercise regimen data is interpreted by the patient device and/or the patient interface to display a human readable exercise regimen information.

At step 44, the therapist may specify a schedule for performing the exercise (e.g. two times each day). For example, the therapist may select a schedule from a menu of options, such as “once per week,” “once per day,” “twice per day,” “three times per day,” etc. This information is also provided by the therapist via the therapist interface 102. Such schedule information is represented by exercise regimen data interpretable by the patient device to display a human readable reminder message and/or configured the patient device to display such a reminder message. In one embodiment, all reminders are displayed at predetermined times as determined by software programming, e.g. all “twice per day” messages are displayed at 11:00 am and 7:00 pm. Alternatively, the therapist interface and/or the patient interface are configured to permit the therapist and/or the patient to specify and/or modify the times for display of the reminder messages in accordance with the therapist-specified schedule (i.e. frequency).

At step 46, it is determined whether the therapist wishes to add additional exercises to the patient's exercise regimen. If so, the process of steps 40-44 repeats. The therapist may repeat steps 40-44 as desired. For example, the therapist may prepare an exercise regimen including 1 set of 5 repetitions of Quad sets, and 1 set of 5 repetitions of Heel digs, each to be performed twice daily.

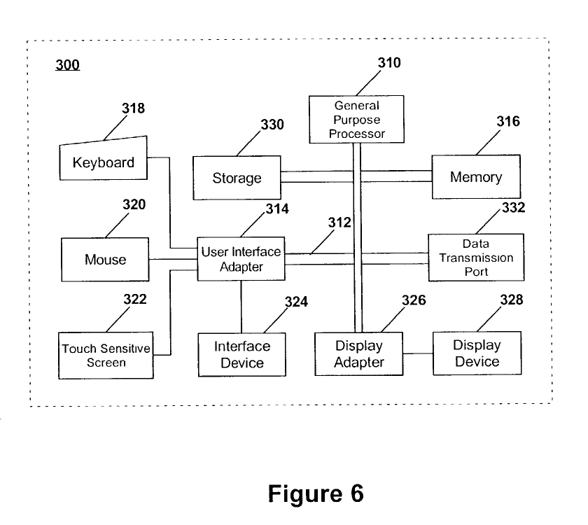

When it is determined at step 46 that the therapist no longer wishes to add additional exercises, such exercise regimen data is stored in a memory of the therapist device in association with the patient identified, as shown at step 48. This may be performed either automatically or as instructed by the therapist (e.g. by selecting a Save command from a drop down menu, etc. as is well known in the art). Such information may then be downloaded to a desktop computer or other centralized database through a “synching” function whereby data is transferred from the electronic device. Such “synching” functions are well known in the art. In this manner, the data may be stored and retained even if the therapist device is rendered inoperable or is unavailable. Storage of such data is discussed in greater detail below with reference to FIG. 6. Such exercise regimen and patient record information is preferably stored in a HIPAA compliant database to preserve the privacy of patient medical records. Additionally, functionality may be provided to import patient identity or other medical record data from a desktop PC to the therapist device 100 during a synching operation for use in preparing an exercise regimen.

At this point, the exercise regimen data resides only in the therapist device 100. The therapist wishes to deliver the exercise regimen to the patient so that the patient may have a record of the exercise regimen and perform the exercise regimen accordingly.

In accordance with the present invention, the exercise regimen is transmitted from the therapist device 100, in the form of data identifying the exercise regimen. In the example of FIG. 3, the data is transmitted from the therapist device 100 to the patient device 200. This is shown in greater detail in steps 50-56 of FIG. 3. Exemplary patient devices 200 are shown in FIGS. 4A and 4B. In a highly preferred embodiment, the data is transmitted by relatively short range (e.g. approximately 1-5 feet) transmission from an infrared data transmission port 110 of the therapist device 100 to an infrared data receiving port 210 of the patient device 200 using known “beaming” technology, or similar technology (see FIG. 1). For example, such a beaming operation may be initiated by selecting a BEAM button 112 of the therapist device. This BEAM button is an output button in that it is configured to initiate transmission of data from the therapist device. In the example of FIGS. 3A and 3B, other output buttons include PRINT and E-MAIL buttons 114, 116 to initiate printing or e-mailing of the exercise regimen data. Alternatively, physical buttons or menu options may be provided to provide similar functionality.

As referred to above, the data is transmitted from the therapist device 100 to the patient device 200. As discussed below, the data transmitted identifies the exercise regimen. For example, the data may identify that the therapist wants the patient to perform 1 set of 5 repetitions of Quad sets, and 1 set of 5 repetitions of Heel digs (see therapist interface 102 of FIG. 3A).

In addition, the therapist device 100 may retrieve exercise information including instruction data representing instructions for performing the exercises, as shown at step 50 of FIG. 3. For example, such instruction data may be retrieved from a database of exercise instructions stored in the memory 316 and/or long term storage 330 of the therapist device (see FIG. 6). For example, such exercise information may be instructions as follows: “Pillow squeeze—Back lying, knees bent, feet flat on floor and slightly apart. Place a folded pillow between the knees. Squeeze knees together as hard as possible for 5 seconds. Relax slowly and repeat.” The instruction data is interpreted by the patient device and/or the patient interface to display a human readable exercise instruction. See FIG. 4A showing exercise instructions 206 displayed via patient interface 202 of patient device 200. Such instruction data may be retrieved from the database and transmitted to the patient for only those exercises selected by the therapist. In this manner, the patient receives only the exercise instructions particular to the patient and the patient's exercise regimen, which reduces or eliminates patient confusion.

In addition, the therapist device 100 may retrieve additional exercise information, namely, image data for displaying images illustrating the exercises, as shown at step 52 of FIG. 3. The image data is interpreted by the patient device to display a human recognizable image illustrating an exercise. Such image data may be stored in the memory 318 and/or long term storage 330 of the therapist device, as discussed above with reference to the instructions for performing the exercises. See FIG. 6. Preferably, only image data particular to the patient's exercise regimen is retrieved, which reduces or eliminates patient confusion.

The exercise instruction data and/or image data retrieved in steps 52 and 54 is transmitted to the receiving data port 210 of the patient device 200 in step 56 of FIG. 3. The patient device 200 interprets the exercise regimen data, exercise instruction data and/or image data and displays, via the patient interface 202 of the patient device 200, exercise regimen information 204, exercise instructions 206 and/or images 208 illustrating performance of exercises identified by the exercise regimen information 204. The exercise regimen information 204, instructions 206 and/or images 208 may be viewed by the patient via the patient interface 202 of the patient device 200 to ensure that the patient performs corresponding exercises properly. In this manner, information traditionally delivered to the patient in paper format and/or photocopies is delivered electronically instead.

In addition, if the patient's electronic device is not yet configured as a patient device 200, the therapist device 100 may also transmit to the patient's electronic device software (in data form) including microprocessor executable instructions for configuring the patient's electronic device as a patient device 200, as shown at step 58. For example, the therapist may elect whether to transmit the software, or the therapist device may transmit the software only if it has never transmitted the software to that patient previously. Alternatively, the therapist device 100 may transmit the software with every transmission of exercise regimen data. The software configures the patient device 200 to display at least a portion of the exercise regimen and exercise information via the patient interface 202. In one embodiment, all data of steps 50-58 may be transmitted to the patient device 200 in a single beaming operation. Alternatively, the therapist may selectively beam such data in separate beaming operations, e.g. to send the microprocessor executable instructions, if necessary, in one beaming operation, and to send exercise regimen data in another beaming operation, etc. In this manner, for example, a therapist may beam software to another therapist's electronic device for configuring the other therapist's electronic device as a therapist device. For subsequent beaming of exercise regimens and/or related information to a particular patient, it may be unnecessary to transmit such microprocessor executable instructions. Such microprocessor executable instructions, and the data referred to above, may be stored by the patient device 200 in its memory (memory 316 and/or long term storage 330) (see FIG. 6) and retained for future reference. The method then ends, as shown at step 59.

FIG. 4 is a flow diagram 60 of a detailed view of the portion of the flow diagram 10 of FIG. 2 relating to use of a patient device 200, shown from the patient device perspective. As shown in FIG. 4, the method starts with receiving of exercise regimen data specifying exercise(s) and repetition(s), i.e. the exercise regimen prepared by the therapist, as shown at steps 61 and 62. Such data is received via the data receiving port 210 of the patient device 200, as shown in FIGS. 4A and 4B.

Similarly, exercise instruction data and/or image data (collectively, exercise information data) are received at the patient device 200 via the data receiving port 210, as shown at step 64 of FIG. 4. Accordingly, step 62 of FIG. 4 corresponds to steps 50 and 56 of FIG. 3.

Similarly, the microprocessor executable instructions for configuring the patient device 200 are received at the patient device 200 via the data receiving port 210, as shown at step 66. Accordingly, step 66 of FIG. 4 corresponds to step 58 of FIG. 3. The microprocessor executable instructions configure the patient device 200 to interpret the exercise regimen data and exercise information data received from the therapist device 100 and cause display corresponding information via the patient interface 202 of the patient device 200. Such corresponding information includes at least a portion of the exercise regimen information 204, exercise instructions 206, exercise images 208, reminder message 212, buttons, e.g. 214, and advertising indicia 216, as shown in FIGS. 4A and 4B and discussed further below.

In this manner, the therapist-prepared exercise regimen is administered to the patient electronically, including preparation of the exercise regimen (and related exercise information) by the therapist via the therapist device, transmission of the exercise regimen (and related exercise information) to the patient via the patient device, and review of the exercise regimen (and related exercise information) by the patient via the patient device to assist in proper performance of the exercise regimen by the patient.

As shown in FIG. 4, the patient device 200 may create a reminder message (see reminder message 212 of FIGS. 4A and 4B) from the exercise regimen data and/or exercise information data received from the therapist device 100. The patient device 200 is configured by the microprocessor executable instructions to interpret such data and cause display of the reminder message in accordance with the schedule specified by the therapist. For example, a reminder message may be displayed twice daily, e.g. at 11:00 am and 7:00 pm to remind the patient to perform the exercises at 11:00 am and 7:00 pm when the therapist has specified performance of the exercises at 11:00 am and 7:00 pm, or twice daily. Alternatively, the reminder message may be displayed once daily, but include descriptive text to prompt the patient to perform the exercises twice daily. Preferably, the reminder message includes the name of the patient and/or the therapist. This information may be included for customization and branding purposes to encourage the patient to comply with the reminder. Any suitable reminder message may be used, as will be appreciated by those skilled in the art. Accordingly, the reminder message 212 is then displayed via the patient interface 202 in accordance with the prescribed schedule, as shown at step 70 of FIG. 4.

The exercise regimen is then displayed via the patient interface 202, as shown at step 72. This may be performed in various ways. For example, a list of all exercises, repetitions and other exercise information may be displayed in list format and be viewable at once on a single display of the patient interface. Alternatively, the exercise regimen may be displayed as a sequence of exercises and be viewable via a sequence of displays on the patient interface. In such an embodiment, as shown in FIGS. 4A and 4B, all information relating to a first exercise of the exercise regimen are displayed, and then all information relating to a next exercise are displayed, for example after the patient taps or otherwise selects a “NEXT” button (see button 214, FIGS. 4A and 4B) to advance to the next display of the patient interface. Exercise regimen information 204, which is interpreted from the exercise regimen data received in step 62 by microprocessor executable instructions received in step 66, relating to a first exercise of an exercise regimen is shown in FIG. 4A. This is advantageous to assist a patient throughout performance of the exercise regimen, and to present only the information pertinent to a current exercise of a plurality of exercises of the exercise regimen to reduce or eliminate possible patient confusion. Many other suitable alternatives will be apparent to those skilled in the art.

Similarly, instructions for performing the exercises 206 (FIGS. 4A and 4B), which are interpreted from the exercise instruction data received in step 64 by microprocessor executable instructions received in step 66, are displayed via the patient interface 202, as shown at step 74 of FIG. 4.

Accordingly, from the patient's perspective, the patient receives data relating to an exercise regimen from a therapist's therapist device 100 via a data receiving port 210 of the patient device 200 (see FIG. 1), views at least a portion of the exercise regimen via the patient interface 202, and performs the exercises indicated by the exercise regimen as indicated via the patient interface 202. The patient may also view instructions, images and/or reminders for performing the exercises via the patient interface, as discussed above.

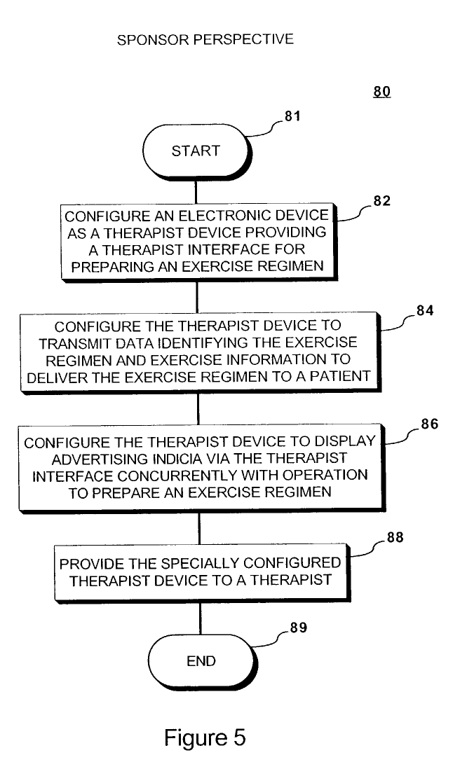

In a highly preferred embodiment of the present invention, the therapist device 100, the patient device 200, and/or the exercise printout 250 of FIG. 4C are further customized to the advantage of a sponsor, such as a manufacturer, distributor, retailer and/or wholesaler of products or services (collectively, “product”). For example, the therapist device 100 may be configured for promoting to a therapist a product relating to a condition treatable with exercise, e.g. such as the sponsor's product. FIG. 5 is a flow diagram 80 of an exemplary method for promoting to a therapist a product relating to a condition treatable with exercise, in accordance with the method of FIG. 2.

As shown in FIG. 5, the method starts with configuring an electronic device to provide a therapist interface 102 permitting a therapist to prepare an exercise regimen via the therapist interface 102, as shown at steps 81 and 82. In other words, the sponsor configures a suitable electronic device, such as a conventional PDA, by installing software for specially configuring the device in accordance with the present invention to provide the therapist interface 102, as discussed above.

The sponsor then configures the electronic device to transmit data identifying the exercise regimen to deliver the exercise regimen to a patient, such as a patient's electronic device (e.g. PDA) 200 or a printer device 390, as shown at step 84. This also may be achieved by installing the software discussed above with reference to step 82.

The sponsor then configures the electronic device to display, via the therapist interface 102, advertising indicia 120 for the product (see FIGS. 3A and 3B), as shown at step 86. This also may be achieved by installing the software discussed above with reference to step 82. For example, FIG. 3A and 3B show advertising indicia 120 for promoting Actonel®, a medication for treating osteoporosis, which is a degenerative bone condition that is treatable by both exercise and medication. The electronic device is configured to display the advertising indicia 120 concurrently with operation of the electronic device to prepare the exercise regimen, as shown in FIGS. 3A and 3B. As used herein, “concurrently” does not necessarily designate simultaneously. Accordingly, it is considered within the scope of “concurrently” to display advertising indicia before or after display of a menu or other information for preparing an exercise regimen, but generally during operation of the device to prepare an exercise regimen.

Steps 82-86 may also involve configuring the therapist device 100 to transmit microprocessor executable instructions and/or data for configuring an electronic device as a therapist device 100 or patient device 200.

As shown in FIG. 5 the sponsor then provides the specially-configured electronic device (the therapist device 100) to the therapist, as shown at step 88. For example, the sponsor may distribute the therapist devices 100 to therapists free of charge. Alternatively, the sponsor may borrow the therapist's electronic device, configure it as a therapist device, and then return the electronic device to the therapist. Alternatively, software may be distributed by mailing of computer media or posting on the Internet for downloading and thereby be made available for installation by the therapist to configure the therapist's electronic device as a therapist device.

In this manner, while the therapist operates the therapist device 100 to prepare an exercise regimen for delivery to a patient having a condition treatable with exercise, the therapist is exposed to advertising indicia 120 related to the patient's condition via the therapist interface 102 that may be beneficial to the patient (see FIGS. 3A and 3B). Accordingly, for example, a physician prescribing an exercise regimen for an osteoporosis patient using the therapist device views the advertising indicia for the Actonel® osteoporosis medication via the therapist interface 102, and therefore may be encouraged to prescribe the medication for the patient, which results in sale of the medication to the benefit of the sponsor. Alternatively, a healthcare consultant preparing an exercise regimen using the therapist device may view the advertising indicia for a therapeutic device or other product via the therapist interface 102 and recommend it to the patient, which will likely result in sale of the device to the benefit of the sponsor. Accordingly, the specially configured therapist device, which provides valuable functionality to a therapist, is used as a medium for advertising to the therapist.

Similarly, the patient device 200 and/or the printout 250 may be configured to display advertising indicia 220 to prompt a patient to inquire about and/or purchase the advertised product, as shown in FIGS. 4A, 4B and 4C. The patient may view such advertising indicia via the patient interface and/or printout while reviewing or performing the exercise regimen. Additionally, the therapist interface 102 and patient interface 202 may be cobranded with additional advertising indicia relating to a hospital, medical practice, pharmaceutical manufacturer, etc.

Accordingly, the present invention provides that the exercise regimen and related exercise information (collectively, “exercise regimen”) may be delivered to the patient in electronic format and displayed via the patient's electronic device (PDA). In this manner, the exercise regimen is administered electronically. The exercise regimen is highly customized for the patient, e.g. to present only exercises selected by the therapist, to indicate repetitions selected by the therapist, and to present illustrative images and instructions that are specific to the exercises selected by the therapist. In addition, the display of the information may be customized, e.g. to display the name of the therapist and/or therapist contact information to allow for resolution of questions/concerns. Additionally, reminder messages may be customized to be patient and/or therapist specific, and to prompt performance of the exercises in accordance with the therapist-specified schedule.

FIG. 6 is a block diagram of an electronic device 300 for use in the present invention. As is well known in the art for PDAs, personal computers, etc., the electronic device includes a general purpose microprocessor 310 and a bus 312 employed to connect and enable communication between the microprocessor 310 and the components of the electronic device 300 in accordance with known techniques. The electronic device 300 typically includes a interface adapter 314, which connects the microprocessor 310 via the bus 312 to one or more interface devices, such as a keyboard 318, mouse 320, touch sensitive screen 322, digitized entry pad, etc. and/or other interface devices 324. The bus 312 also connects a display device 328, such as an LCD screen or monitor, to the microprocessor 310 via a display adapter 326. The bus 312 also connects the microprocessor 310 to memory 316 and long-term storage 330 (collectively, “memory”) which can include a hard drive, diskette drive, tape drive, etc.

The electronic device 300 may communicate with other electronic devices, computers or networks of computers, etc. via a data port 330. For example the data port may include a data receiving port and/or a data transmission port, each of which may include an infrared, wireless data transmission port. Additionally, the data port 330 may include parallel, serial, or other well-known data ports, e.g. for synching to a personal computer, etc. All of these configurations, as well as the appropriate communications hardware and software, are well known in the art.

Software programming code, i.e. microprocessor executable instructions, embodying the present invention is typically stored in memory of some type, such as memory 316 and/or storage 330. The electronic device 300 may be configured as either a therapist device (see FIGS. 3A and 3B) or a patient device (see FIGS. 4A and 4B). When configured as a therapist device, the electronic device 300 stores in its memory 316 and/or storage 330 (collectively, “memory”), microprocessor executable instructions including first instructions to provide a therapist interface, second instructions to display, via the therapist interface, a menu of user-selectable exercise options, third instructions to receive, via the therapist interface, user-selected exercise information specifying an exercise regimen, and fourth instructions to transmit, from the therapist device, data identifying the exercise regimen to deliver the exercise regimen to a recipient. Optionally, the therapist device may store in its memory fourth instructions to transmit the data via the data transmission port, and/or fifth instructions to display, via the therapist interface, advertising indicia concurrently with display of the menu.

Additionally, the electronic device 300, when configured as a therapist device, may store in its memory 316 and/or long term storage 330, databases of exercise information including exercise instructions, images illustrating performance of exercises, patient medical records, previously prepared exercise regimens, etc.

Alternatively, the electronic device 300 may be configured as a patient device 200 by storing in its memory instructions for carrying out the steps described above with reference to FIGS. 2-5.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for administering an exercise regimen using a therapist device having a microprocessor and a memory and data transmission port operatively connected to the microprocessor, the therapist device being configured to provide a therapist interface, the method comprising:
preparing an exercise regimen comprising exercise information, the exercise regimen being prepared via the therapist interface; and
transmitting data identifying the exercise regimen to deliver the exercise regimen to a recipient, the data being transmitted from the data transmission port of the therapist device to a data receiving port of a receiving device.

2. The method of claim 1, wherein the exercise information identifies an exercise, the method further comprising:
retrieving instructions for performing the exercise from a database stored in the memory of the therapist device; and
transmitting data identifying the instructions for performing the exercise to deliver the instructions to the recipient, the data identifying the instructions for performing the exercise being transmitted from the data transmission port of the therapist device to the data receiving port of the receiving device.

3. The method of claim 1, further comprising:
identifying, via the therapist interface, the recipient; and
storing, in the memory of the therapist device, the data identifying the exercise regimen in association with the recipient identified.

4. The method of claim 1, wherein the receiving device comprises a printer device having the data receiving port, and wherein the transmitting comprises at least:
causing the printer device to create a printout displaying the exercise regimen.

5. The method of claim 4, wherein the transmitting further comprises tendering a copy of the printout to the recipient.

6. The method of claim 1, wherein the transmitting is performed by wireless transmission.

7. The method of claim 6, wherein the data transmission port comprises an infrared transmission port, and wherein the wireless transmission comprises transmitting the data via the infrared transmission port.

8. The method of claim 1, wherein the receiving device comprises a recipient device having a microprocessor and a memory and data receiving port operatively connected to the microprocessor, the recipient device being configured to provide a recipient interface, the method further comprising:
transmitting microprocessor executable instructions for configuring the recipient device to display at least a portion of the exercise information via the recipient interface, the microprocessor executable instructions being transmitted from the data transmission port of the therapist device to the data receiving port of the recipient device.

9. The method of claim 8, wherein the data transmission port of the therapist device comprises an infrared transmission port, wherein the data receiving port of the recipient device comprises an infrared transmission port, and wherein the data identifying the exercise regimen is transmitted from the infrared transmission port of the therapist device to the infrared transmission port of the recipient device.

10. The method of claim 8, wherein the exercise information identifies an exercise, the method further comprising:
retrieving image data for displaying an illustration of the exercise, the image data being retrieved from a database stored in the memory of the therapist device; and
transmitting the image data to deliver the image data to the recipient, the image data being transmitted from the data transmission port of the therapist device to the data receiving port of the recipient device.

11. The method of claim 8, wherein the exercise information identifies a schedule for performing an exercise, the method further comprising:
transmitting reminder data for configuring the recipient device to display a reminder to perform the exercise in accordance with the schedule, the reminder data being transmitted from the data transmission port of the therapist device to the data receiving port of the receiving device.

12. The method of claim 8, wherein the exercise information identifies an exercise, the method further comprising:
retrieving instructions for performing the exercise from a database stored in the memory of the therapist device; and
transmitting data identifying the instructions for performing the exercise to deliver the instructions to the recipient, the data identifying the instructions being transmitted from the data transmission port of the therapist device to the data receiving port of the recipient device.

13. A computer readable medium for administering an exercise regimen using a therapist device having a microprocessor and a memory and data transmission port operatively connected to the microprocessor and configured to provide a therapist interface, the computer readable medium comprising computer readable instructions for:
displaying, via the therapist interface, a menu of user-selectable exercise options;
receiving, via the therapist interface, user-selected exercise information specifying an exercise regimen; and
transmitting, from the electronic device, data identifying the exercise regimen to deliver the exercise regimen to a recipient.

14. The computer readable medium of claim 13, further comprising computer readable instructions for:
displaying, via the therapist interface, advertising indicia, the advertising indicia being displayed concurrently with display of the menu.

15. The computer readable medium of claim 14, wherein the advertising indicia is associated with a sponsor that has distributed the electronic device to the user.

16. The computer readable medium of claim 13, wherein the advertising indicia is associated with a product relating to a condition treatable with exercise.

17. The computer readable medium of claim 13, wherein the menu comprises user-selectable exercise options.

18. The computer readable medium of claim 13, wherein the menu comprises user-selectable repetition options.

19. The computer readable medium of claim 13, further comprising computer readable instructions for:
transmitting, from the therapist device, microprocessor executable instructions for configuring the recipient's electronic device to display at least a portion of the exercise information.

20. A therapist device for administering an exercise regimen, said therapist device comprising:
a microprocessor;
a memory operatively connected to the microprocessor;
a data transmission port operatively connected to the microprocessor;
first computer readable instructions stored in the memory and executable by the microprocessor to provide a therapist interface;
second computer readable instructions stored in the memory and executable by the microprocessor to display, via the therapist interface, a menu of user-selectable exercise options;
third computer readable instructions stored in the memory and executable by the microprocessor to receive, via the therapist interface, user-selected exercise information specifying an exercise regimen; and
fourth computer readable instructions stored in the memory and executable by the microprocessor to transmit, from the therapist device, data identifying the exercise regimen to deliver the exercise regimen to a recipient.

21. The therapist device of claim 20, further comprising a data transmission port operatively connected to the memory and microprocessor, the fourth computer readable instructions being configured to transmit the data via the data transmission port.

22. The therapist device of claim 21, wherein said data transmission port comprises an infrared transmission port.

23. The therapist device of claim 20, further comprising:
fifth computer readable instructions stored in the memory and executable by the microprocessor to display, via the therapist interface, advertising indicia concurrently with display of the menu.

24. A method for promoting to a therapist a product relating to a condition treatable with exercise, the method comprising:
configuring an electronic device to provide a therapist interface permitting the therapist to prepare an exercise regimen, the electronic device having a microprocessor and a memory and data transmission port operatively connected to the microprocessor;
configuring the electronic device to transmit data identifying the exercise regimen to deliver the exercise regimen to a recipient; and
configuring the electronic device to display, via the therapist interface, advertising indicia for the product, the electronic device being configured to display said advertising indicia concurrently with operation of the electronic device to prepare the exercise regimen.

25. The method of claim 24, further comprising the step of:
providing the electronic device to the therapist.

26. The method of claim 25, wherein the advertising indicia is associated with a sponsor that has provided the electronic device.

27. A graphical user interface for administering an exercise regimen using a therapist device having a microprocessor, a memory operatively connected to the microprocessor and a data transmission port, said graphical user interface comprising:
a menu of exercise options, said menu of exercise options being user-selectable to prepare an exercise regimen; and
an output button, said output button being configured to initiate transmission of data identifying said exercise regimen from said therapist device via said data transmission port.

28. The graphical user interface of claim 27, further comprising:
advertising indicia promoting a product related to a condition treatable by exercise.

29. The graphical user interface of claim 27, wherein said menu comprises a plurality of exercises.

30. The graphical user interface of claim 27, wherein said menu comprises a plurality of repetitions.
